(19) United States
(12) Patent Application Publication
(10) Pub. No.: US 2012/0015276 A1
(43) Pub. Date: Jan. 19, 2012

(54) SOLID OXIDE FUEL CELL AND FUEL CELL STACK

(75) Inventors: Hyun Soh, Yongin-si (KR); Young-Kee Kim, Yongin-si (KR)

(73) Assignee: SAMSUNG SDI CO., LTD., Yongin-si (KR)

(21) Appl. No.: 13/093,276

(22) Filed: Apr. 25, 2011

(30) Foreign Application Priority Data
Jul. 15, 2010 (KR) 10-2010-0068465

(51) Int. Cl. H01M 8/24; H01M 8/10

(52) U.S. Cl. 429/466; 429/495

(57) ABSTRACT

A solid oxide fuel cell including a unit cell formed into a structure in which a first electrode, an electrolytic layer and a second electrode are sequentially stacked is disclosed. The unit cell of solid oxide fuel cell may include a plurality of contact grooves formed on an outer circumferential surface of the second electrode and may include current collectors respectively mounted on and in surface contact with the contact grooves of the second electrode. The current collectors may be symmetrically arranged with respect to the center axis of the unit cell. Current collection efficiency may thus be enhanced. Further, current collectors may be shared by adjacent unit cells, so that it is possible to manufacture a stack with excellent economical efficiency.

### CROSS-REFERENCE TO RELATED APPLICATIONS

This application claims priority to and the benefit of Korean Patent Application No. 10-2010-0068465, filed on Jul. 15, 2010, in the Korean Intellectual Property Office, the entire content of which is incorporated herein by reference.

### BACKGROUND

1. Field of the Disclosure

The present disclosure relates to a solid oxide fuel cell having high power efficiency and a fuel cell stack including the solid oxide fuel cell.

2. Description of the Related Technology

A solid oxide fuel cell has a structure in which a first electrode, an electrolytic layer and a second electrode are sequentially stacked. When the second electrode is a cathode, a current collector for extracting current may be formed on an outer circumferential surface of the cathode. However, when a wire current collector contacts the outer circumferential surface of the cathode the area contacting the cathode is too small, and thus has high contact resistance. If the contact resistance is too high due to small contact area between the wire current collector and the outer circumferential surface of the cathode, power loss occurs during current extraction. Further, the current collector is often formed of a precious metal with high conductivity, such as silver (Ag), platinum (Pt) or nickel (Ni). Such precious metals with high conductivity increase manufacturing cost of a fuel cell. It is therefore desirable to develop improved structures of current collectors, which may reduce the amount of precious metals used in the current collector and/or may reduce power loss due to high contact resistance.

### SUMMARY OF CERTAIN INVENTIVE ASPECTS

In one aspect, a solid oxide fuel cell and a fuel cell stack are provided, which minimize the contact resistance between an electrode and current collectors in a unit cell.

In another aspect, contact resistance between an electrode and current collectors in a unit cell is minimized so that current collection efficiency is improved.

In another aspect, a reaction surface area of the unit cell is increased and adjacent unit cells share current collectors with each other so that a fuel cell stack can be economically and/or effectively manufactured.

In another aspect, a solid oxide fuel cell including, for example, a unit cell formed into a structure in which a first electrode, an electrolytic layer and a second electrode are sequentially stacked is provided. In some embodiments, the unit cell includes, for example, a plurality of contact grooves formed on an outer circumferential surface of the second electrode. In some embodiments, current collectors are formed on the contact grooves such that the current collectors contact the second electrode. In some embodiments, the current collectors are symmetrically arranged with respect to a center axis of the unit cell.

In some embodiments, the unit cell is formed into a polygonal structure. In some embodiments, the contact groove is symmetrically formed at each side of the second electrode. In some embodiments, the contact groove is formed in a semi-circular shape. In some embodiments, the current collector contacts the contact groove with the semi-circular shape at a predetermined depth. In some embodiments, the cross section of the current collector is formed in a circular shape. In some embodiments, the first electrode is an anode and the second electrode is a cathode. In some embodiments, the contact grooves or the current collectors are formed in parallel to a length direction of the unit cell.

In another aspect, a solid oxide fuel cell stack including, for example, a plurality of unit cells with a regular rectangular structure is provided. In some embodiments, each unit cell includes, for example, a first electrode, an electrolytic layer and a second electrode, sequentially stacked. In some embodiments, each unit cell includes, for example, a plurality of contact grooves formed on an outer circumferential surface of the second electrode. In some embodiments, current collectors are formed on the contact grooves such that the current collectors contact the second electrode. In some embodiments, the current collectors of each of the unit cells are symmetrically formed with respect to a center axis of each unit cell. In some embodiments, at least one of the current collectors is shared by adjacent unit cells.

In some embodiments, the current collector is formed between contact grooves of adjacent unit cells. In some embodiments, the contact groove is symmetrically formed at each of the sides of the second electrode. In some embodiments, the contact groove of at least one unit cell is formed in a semi-circular shape. In some embodiments, the current collector is contacts the contact groove with the semi-circular shape at a predetermined depth. In some embodiments, the unit cell is formed into a hexagonal structure. In some embodiments, the stack is formed into a hexagonal structure. In some embodiments, an air path is formed at the center of the stack. In some embodiments, a cross-sectional area of the air path is identical to that of a cross-sectional area of at least one of the plurality of unit cells.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a perspective view showing an anode-supported unit cell.

FIG. 2 is a cross-sectional view of the unit cell shown in FIG. 1.

FIG. 3 is a cross-sectional view of a unit cell according to an embodiment of the present disclosure.

FIG. 4 is a cross-sectional view of a stack according to an embodiment of the present disclosure.

FIG. 5 is a cross-sectional view of a stack according to another embodiment of the present disclosure.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Similarly, when it is described that an element is “coupled” to another element, the another element may be “directly coupled” to the other element or “electrically coupled” to the other element through a third element. Parts not related to the description are omitted for clarity. Hereinafter, like reference numerals refer to like elements. In the drawings, the thickness or size of layers are exaggerated for clarity and not necessarily drawn to scale. Certain embodiments will be described in more detail with reference to the accompanying drawings, so that a person having ordinary skill in the art can readily make and use aspects of the present disclosure.

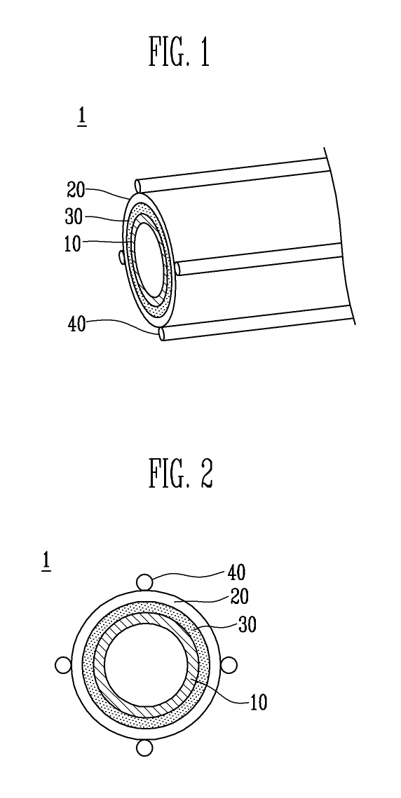

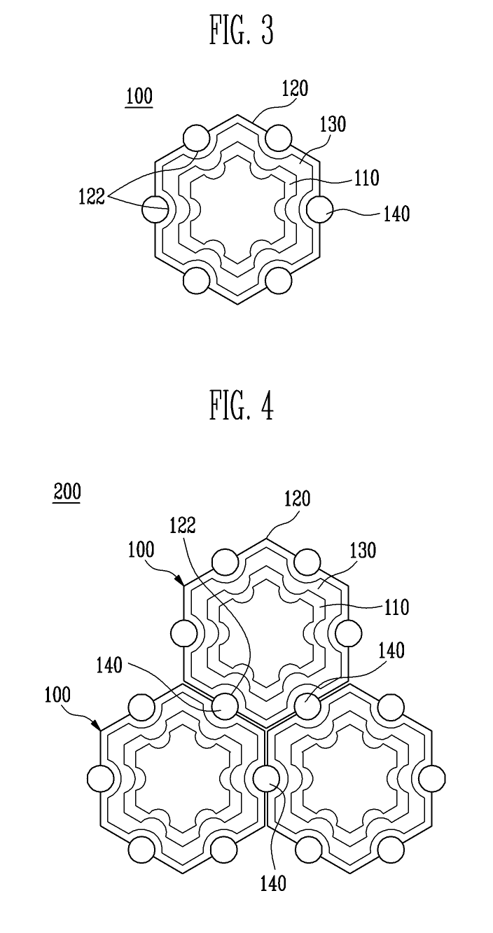

FIG. 1 shows a cylindrical unit cell using an anode as a support body in a solid oxide fuel cell. FIG. 2 is a cross-sectional view of the unit cell shown in FIG. 1. The fuel cell 1 in the solid oxide fuel cell shown in these figures is a cylindrical fuel cell having an anode-supported structure. The fuel cell 1 includes an anode 10, a cathode 20 and an electrolytic layer 30 positioned therebetween. Current collectors 40 for extracting current are formed on the outer circumferential surface of the cathode 20. However, in the unit cell 1 shown in FIG. 1, the contact area between the cathode 20 and the current collectors 40 for extracting electricity generated from the cathode 20 is too small, and therefore, contact resistance between the cathode 20 and the current collectors 40 may be too high for optimal efficiency.

Although not shown in these figures, a wire-shaped current collector may be spirally wound around the outer circumferential surface of the cathode. In a case where the current collector is spirally wound, the contact area between the cathode and the current collector is small, and therefore, the contact resistance between the cathode and the current collector may be high as shown in FIGS. 1 and 2.

FIG. 3 is a cross-sectional view of a unit cell according to an embodiment of the present disclosure. As shown in FIG. 3, the unit cell 100 according to this embodiment is formed into a polygonal structure, and includes a first electrode 110, an electrolytic layer 130 and a second electrode 120, sequentially stacked, and current collectors 140 for extracting current that flows through the first and second electrodes 110 and 120 to the exterior of the unit cell 100. The current collectors 140 for extracting the current generated from the electrodes mechanically and electrically contact the outer circumferential surface of the second electrode 120.

In this embodiment, the polygonal structure of the unit cell 100 increases surface area of the electrode for reaction purposes. Particularly, the unit cell 100 may be formed into a regular hexagonal structure. However, the structure of the unit cell 100 may be selected from polygonal structures in consideration of several factors such as the increase in the surface area of the electrode and the efficiency of the current collectors.

Meanwhile, the unit cell 100 shown in FIG. 3 illustrates an anode-supported structure in which the first electrode 110 is an anode and the second electrode 120 is a cathode. In FIG. 3, the current collectors 140 are arranged in parallel with the longitudinal axis of the unit cell 100, for example, the length direction of the unit cell 100. However, it will be apparent that the current collectors 140 may be formed perpendicular to the longitudinal axis of the unit cell 100. In this embodiment, the current collector 140 is formed in the shape of a wire of which section is a circle. Alternatively, the current collector 140 may be formed in a prismatic shape.

The cross section of each of the first electrode 110, the electrolytic layer 130 and the second electrode 120 in the unit cell 100 illustrates a structure in which a semi-circular groove may be formed at each side of the regular hexagon. A contact groove 122 that is the semi-circular groove may be symmetrically formed at each of the sides of the second electrode 210, and the current collectors 140 are mounted on the contact grooves 122, respectively. In this instance, it is necessary to mount the current collector 140 on the contact groove 122 until it comes in contact with the contact groove 122. In a case where the current collector 140 is mounted on and mechanically and electrically contacts the contact groove 122, the contact resistance between the current collector 140 and the contact groove 122 can be improved as compared with the contact of current collectors 40 and the cathode 20 of the embodiments illustrated in FIGS. 1 and 2. The reason why the current collectors 140 are formed opposite to each other with respect to the center axis of the unit cell 100 is that uniform current collection may be more easily performed with uniform distribution of current in the unit cell 100 having a polygonal structure.

Meanwhile, the first electrode 110 has a hollow structure through which fuel passes and serves as a support body of the unit cell 100. The first electrode 110 that is an anode may be made of a cermet of metal nickel and oxide ion collector, Ni/YSZ, or the like. Here, YSZ stands for yttria stabilized zirconia, and will be used herein below.

Generally, the metal nickel has high electron conductivity and high electrode catalyst activity due to the absorption of hydrogen and hydrocarbon-based fuel. Also, nickel is cheaper than platinum or the like. In the first electrode 110 of this embodiment, a concave groove may be formed at a position corresponding to each of the contact grooves 122 of the second electrode 120. In the electrolytic layer 130 which will be described later, a concave groove may be formed at a position corresponding to each of the contact grooves 122 of the second electrode 120. The concave grooves may not be formed through a separate process. In the manufacture of the first electrode, the electrolytic layer and the second electrode of the unit cell 100, the concave grooves may be formed together when the semi-circular grooves 122 during the same process when the second electrode 120 are formed.

As described above, concave grooves or contact grooves are formed on the outer circumferential surface of each of the first electrode 110, the electrolytic layer 130 and the second electrode 120, so that a structure may be formed in which reaction can be promoted while the surface area of the first electrode 110 that contacts the electrolytic layer 130 is increased.

Meanwhile, the electrolytic layer 130 is positioned between the first electrode 110 and the second electrode 120. In this embodiment, the unit cell 100 has a structure in which air is supplied to the outer circumferential surface of the second electrode 120. The second electrode 120 may be formed of LaSrMnO₃ (LSM) having excellent catalytic resolution and electron conductivity among Perovskite-type oxides. Oxygen may be converted into oxygen ions by a catalytic reaction with LaMnO₃.

As described above, the second electrode 120 that is a cathode contacts the current collector 140 through the contact groove 122 formed at a portion of the outer circumferential surface thereof. That is, the current collector 140 is mounted on the contact groove 122, so that the contact area between the second electrode 120 and the current collector 140 may be increased. Through such a structure, the contact resistance between the second electrode 120 and the current collector 140 may be remarkably decreased as during the operation of the solid oxide fuel cell current is transferred from the second electrode 120 to the current collector 140. Further, the area at which the outer circumferential surface of the second electrode 120 contacts air is enlarged, so that an electrode reaction may occur.

The contact groove 122 is formed in the length direction of the unit cell on each side of the second electrode 120. The current collector 140 may be mounted to have a depth in which it comes in surface contact with the contact groove 122 and may be formed opposite or symmetric with respect to the center axis of the second electrode 120. Through the current collector 140 with the symmetric structure, uniform current collection may easily occur in the unit cell. Further, through the current collector 140 with the symmetric structure, adjacent unit cells can share the current collector with each other in the manufacture of a stack which will be described later. The current collector 140 is formed such that it may be shared by adjacent unit cells in the stack, thus reducing the consumption amount of current collectors and more effectively manufacturing the stack using an effective packing process.

As shown in FIG. 3, the electrolytic layer 130 is positioned between the first and second electrodes 110 and 120, and may be formed as thin as possible. The electrolytic layer 130 may be made of electrolyte YSZ. More specifically, the YSZ may be formed by doping zirconia (ZrO₂) with yttria (Y2O₃). The YSZ is an electrolyte activated at a high temperature of about 800° C. to about 1000° C., and about 3% to about 10% yttria (Y2O₃) is usually melted in the zirconia (ZrO₂).

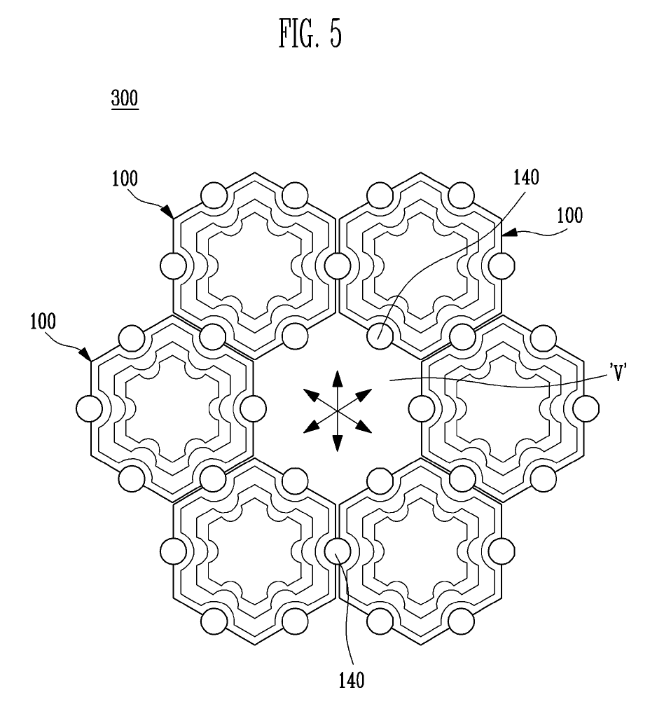

FIG. 4 is a cross-sectional view of a stack according to another embodiment of the present disclosure. A stack 200 formed by integrating a plurality of unit cells 100 shown in FIG. 3 is shown in FIG. 4. Although only three unit cells 100 are shown in FIG. 4 for convenience of illustration, the stack 200 may be formed by integrating three or more unit cells 100. In the stack 200 shown in FIG. 4, the three unit cells 100 share three current collectors 140 with one another. As described above, the unit cells 100 that constitute the stack 200 share the current collectors 140 with one another, so that it may be possible to decrease the consumption amount and entire length of the current collectors 140 through current generated from the unit cells 100 moves. Further, the current collectors are symmetrically arranged with respect to the center axis of each of the unit cells of the stack, so that uniform current collection may be performed in the stack, thereby enhancing current collection efficiency.

FIG. 5 is a cross-sectional view of a stack according to another embodiment of the present disclosure. Referring to FIG. 5, in a stack 300 including six unit cells 100, six current collectors 140 are shared between adjacent unit cells 100. Each unit cell 100 is formed into a regular hexagonal structure, and the stack 300 is also formed into a regular hexagonal structure. In a case where the unit cell 100 is formed into a polygonal structure, particularly a regular polygonal structure, it is possible to simplify the entire packing of the stack and to effectively manufacture the sack. Although the stack formed by connecting the six unit cells is shown in FIG. 5, an additional unit cell may be formed in the center of the stack, thereby forming the structure of a stack including seven unit cells. In FIG. 5, an air path V configured to enable air to pass therethrough is formed at the center of the stack 300. The size of the air path may be formed identical to that of each of the unit cells 100. In the entire structure of the stack 300, the degree of freedom in changing the structure can be enhanced because of the air path V.

While the present invention has been described in connection with certain exemplary embodiments, it will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A solid oxide fuel cell comprising a unit cell formed into a structure in which a first electrode, an electrolytic layer and a second electrode are sequentially stacked, wherein the unit cell comprises a plurality of contact grooves formed on an outer circumferential surface of the second electrode, wherein current collectors are formed on the contact grooves such that the current collectors contact the second electrode, and wherein the current collectors are symmetrically arranged with respect to a center axis of the unit cell.

2. The solid oxide fuel cell of claim 1, wherein the unit cell is formed into a polygonal structure.

3. The solid oxide fuel cell of claim 2, wherein the contact groove is symmetrically formed at each side of the second electrode.

4. The solid oxide fuel cell of claim 2, wherein the contact groove is formed in a semi-circular shape.

5. The solid oxide fuel cell of claim 4, wherein the current collector contacts the contact groove with the semi-circular shape at a predetermined depth.

6. The solid oxide fuel cell of claim 5, wherein the cross section of the current collector is formed in a circular shape.

7. The solid oxide fuel cell of claim 1, wherein the first electrode is an anode and the second electrode is a cathode.

8. The solid oxide fuel cell of claim 1, wherein the contact grooves or the current collectors are formed in parallel to a length direction of the unit cell.

9. A solid oxide fuel cell stack comprising a plurality of unit cells with a regular rectangular structure, wherein each unit cell comprises a first electrode, an electrolytic layer and a second electrode, sequentially stacked, wherein each unit cell comprises a plurality of contact grooves formed on an outer circumferential surface of the second electrode, wherein current collectors are formed on the contact grooves such that the current collectors contact the second electrode, wherein the current collectors of each of the unit cells are symmetrically formed with respect to a center axis of each unit cell, and wherein at least one of the current collectors is shared by adjacent unit cells.

10. The solid oxide fuel cell stack of claim 9, wherein the current collector is formed between contact grooves of adjacent unit cells.

11. The solid oxide fuel cell stack of claim 9, wherein the contact groove is symmetrically formed at each of the sides of the second electrode.

12. The solid oxide fuel cell stack of claim 9, wherein the contact groove of at least one unit cell is formed in a semi-circular shape.

13. The solid oxide fuel cell stack of claim 12, wherein the current collector is contacts the contact groove with the semi-circular shape at a predetermined depth.

14. The solid oxide fuel cell stack of claim 9, wherein the unit cell is formed into a hexagonal structure.

15. The solid oxide fuel cell stack of claim 14, wherein the stack is formed into a hexagonal structure.

16. The solid oxide fuel cell stack of claim 15, wherein an air path is formed at the center of the stack.

17. The solid oxide fuel cell stack of claim 16, wherein a cross-sectional area of the air path is identical to that of a cross-sectional area of at least one of the plurality of unit cells.
